(19) United States
(12) Patent Application Publication
(10) Pub. No.: US 2022/0113724 A1
(43) Pub. Date: Apr. 14, 2022

(54) INFORMATION PROCESSING DEVICE, ROBOT SYSTEM, AND INFORMATION PROCESSING METHOD

(71) Applicant: PREFERRED NETWORKS, INC., Tokyo (JP)

(72) Inventors: Kuniyuki TAKAHASHI, Tokyo (JP); Tomoki ANZAI, Tokyo (JP)

(73) Assignee: PREFERRED NETWORKS, INC., Tokyo (JP)

(21) Appl. No.: 17/561,440

(22) Filed: Dec. 23, 2021

Related U.S. Application Data
(63) Continuation of application No. PCT/JP2020/026254, filed on Jul. 3, 2020.

(30) Foreign Application Priority Data
Jul. 3, 2019 (JP) 2019-124549

(51) Int. Cl. G05D 1/00; G06V 20/56; G06V 10/82; G06T 7/70; G06N 3/04

(52) U.S. Cl. CPC G05D 1/0088; G06V 20/56; G06V 10/82; G06T 2207/30252; G06N 3/0454; G06T 2207/20084; G06T 7/70

(57) ABSTRACT

An information processing device according to an embodiment includes processing circuitry. The processing circuitry is configured to acquire image information of an object and tactile information indicating the condition of contact of a grasping device with the object. The processing circuitry is configured to grasp the object. The processing circuitry is configured to obtain output data indicating at least one of the positions and the posture of the object on the basis of at least one of a first contribution of the image information and a second contribution of the tactile information.

### CROSS-REFERENCE TO RELATED APPLICATIONS

This application is based upon and claims the benefit of priority from Japanese Patent Application No. 2019-124549, filed on Jul. 3, 2019, and International Patent Application No. PCT/JP2020/026254 filed on Jul. 3, 2020; the entire contents of all of which are incorporated herein by reference.

### FIELD

Embodiments described herein relate to an information processing device, a robot system, and an information processing method.

### BACKGROUND

Conventionally, a robot system that grasps and carries an object with a grasping part (such as a hand part) has been known. Such a robot system estimates the position, the posture, and the like of each object from image information obtained by taking an image of the object, for example, and controls its grasp of the object on the basis of the estimated information.

### BRIEF SUMMARY OF THE INVENTION

An information processing device comprises processing circuitry. The processing circuitry is configured to acquire image information of an object and tactile information indicating a condition of contact of a grasping device with the object, the grasping device being configured to grasp the object. The processing circuitry is configured to obtain output data indicating at least one of a position and an posture of the object, based on at least one of a first contribution of the image information and a second contribution of the tactile information.

### BRIEF DESCRIPTION OF THE DRAWINGS

FIG. 1 is a diagram illustrating an exemplary hardware configuration of a robot system including an information processing device according to an embodiment;

FIG. 2 is a diagram illustrating an exemplary configuration of a robot;

FIG. 3 is a block diagram of hardware of the information processing device;

FIG. 4 is a functional block diagram illustrating an example of a functional configuration of the information processing device;

FIG. 5 is a diagram illustrating an exemplary configuration of a neural network;

FIG. 6 is a flowchart illustrating an example of training processing according to the embodiment;

FIG. 7 is a flowchart illustrating an example of control processing according to the embodiment; and

FIG. 8 is a flowchart illustrating an example of abnormality detection processing according to a modification.

### DETAILED DESCRIPTION OF THE INVENTION

Exemplary embodiments will be described below in detail with reference to the accompanying drawings.

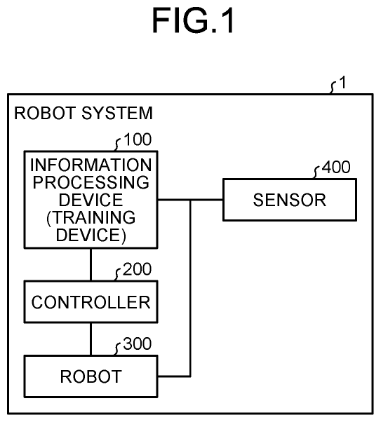

FIG. 1 is a diagram illustrating an exemplary hardware configuration of a robot system 1 including an information processing device 100 according to the present embodiment. As illustrated in FIG. 1, the robot system 1 includes the information processing device 100, a controller 200, a robot 300, and a sensor 400.

The robot 300 is an example of a mobile device that moves with at least one of the position and the posture (trajectory) controlled by the information processing device 100. The robot 300 includes a grasping part (grasping device) that grasps an object, a plurality of links, a plurality of joints, and a plurality of drives (such as motors) that drive each joint, for example. A description will be given below by taking, as an example, the robot 300 that includes at least a grasping part for grasping an object and moves the grasping object.

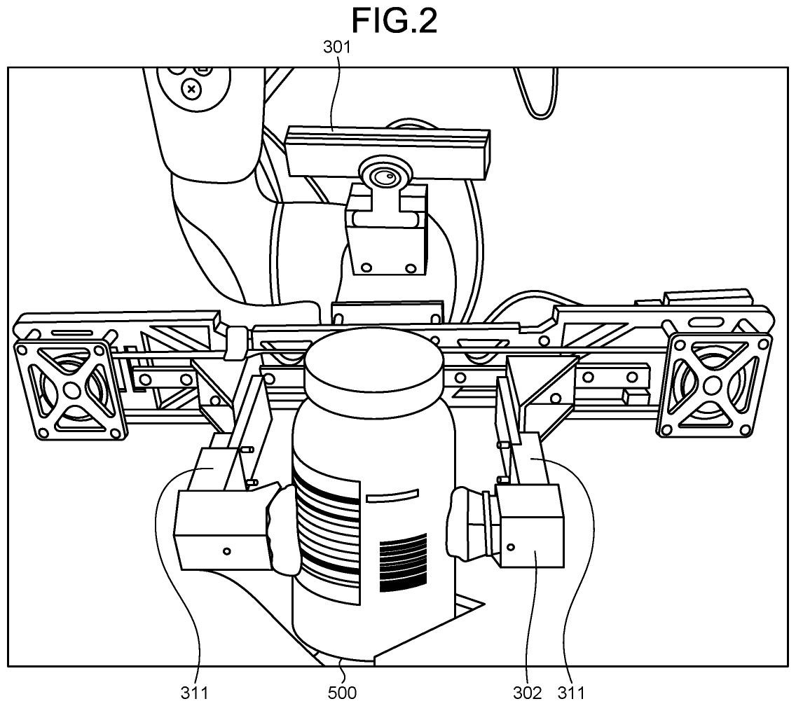

FIG. 2 is a diagram illustrating an exemplary configuration of the robot 300 configured in this manner. As illustrated in FIG. 2, the robot 300 includes a grasping part 311, an imaging unit (imaging device) 301, and a tactile sensor 302. The grasping part 311 grasps an object 500 to be moved. The imaging unit 301 is an imaging device that takes an image of the object 500 and outputs image information. The imaging unit 301 does not have to be included in the robot 300, and may be installed in the outside of the robot 300.

The tactile sensor 302 is a sensor that acquires tactile information indicating the condition of contact of the grasping part 311 with the object 500. The tactile sensor 302 is, for example, a sensor that outputs, as tactile information, image information obtained by causing a elastomer material to contact the object 500, and an imaging device different from the imaging unit 301 taking an image of a displacement of the elastomer material resulting from the contact. In this manner, tactile information may be information indicating the condition of contact in an image format. The tactile sensor 302 is not limited to this, and may be any kind of sensor. For example, the tactile sensor 302 may be a sensor that senses tactile information by using at least one of the pressure, resistance, and capacitance caused by the contact of the grasping part 311 with the object 500.

The applicable robot (mobile device) is not limited to this, and may be any kind of robot (mobile device). For example, the applicable robot may be a robot, a mobile manipulator, and a mobile robot including one joint and link. The applicable robot may also be a robot including a drive to translate the entire robot in a given direction in a real space. The mobile device may be an object the entire position of which changes in this manner, or may be an object the position of a part of which is fixed and at least one of the position and posture of the rest changes.

The description returns to FIG. 1. The sensor 400 detects information to be used to control the operation of the robot 300. The sensor 400 is a depth sensor that detects depth information to the object 500, for example. The sensor 400 is not limited to a depth sensor. Also, the sensor 400 does not have to be included. The sensor 400 may be the imaging unit 301 installed in the outside of the robot 300 as described above. The robot 300 may include the sensor 400, such as a depth sensor.

The controller 200 controls the drive of the robot 300 in response to an instruction from the information processing device 100. For example, the controller 200 controls the grasping part 311 of the robot 300 and a drive (such as a motor) that moves joints and the like so that rotation is made in the rotation direction and at the rotation speed specified by the information processing device 100.

The information processing device 100 is connected to the controller 200, the robot 300, and the sensor 400 and controls the entire robot system 1. For example, the information processing device 100 controls the operation of the robot 300. Controlling the operation of the robot 300 includes processing to operate (move) the robot 300 on the basis of at least one of the position and the posture of the object 500. The information processing device 100 outputs, to the controller 200, an operation command to operate the robot 300. The information processing device 100 may include a function of training a neural network to estimate (infer) at least one of the position and the posture of the object 500. In this case, the information processing device 100 functions also as a training device that trains the neural network.

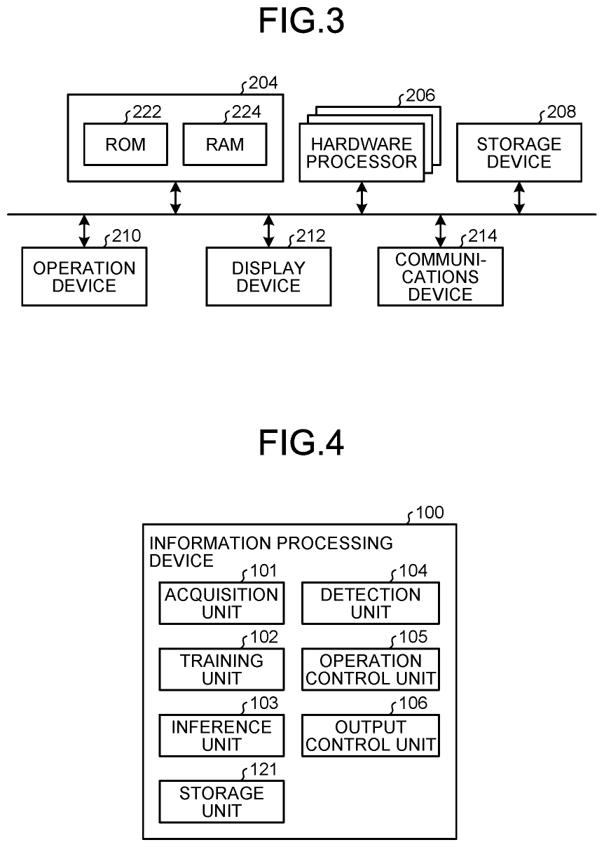

FIG. 3 is a block diagram of hardware of the information processing device 100. The information processing device 100 is implemented by a hardware configuration similar to a general computer (information processing device) as illustrated in FIG. 3, as an example. The information processing device 100 may be implemented by a single computer as illustrated in FIG. 3, or may be implemented by a plurality of computers that run in cooperation with each other.

The information processing device 100 includes a memory 204, one or more hardware processors 206, a storage device 208, an operation device 210, a display device 212, and a communications device 214. The units are connected on a bus. The one or more hardware processors 206 may be included in a plurality of computers that run in cooperation with each other.

The memory 204 includes ROM 222 and RAM 224, for example. The ROM 222 stores therein computer programs to be used to control the information processing device 100, a variety of configuration information, and the like in a non-rewritable manner. The RAM 224 is a volatile storage medium, such as synchronous dynamic random access memory (SDRAM). The RAM 224 functions as a work area of the one or more hardware processors 206.

The one or more hardware processors 206 are connected to the memory 204 (the ROM 222 and the RAM 224) via the bus. The one or more hardware processors 206 may be one or more central processing units (CPUs), or may be one or more graphics processing units (GPUs), for example. The one or more hardware processors 206 may also be one or more semiconductor devices or the like including processing circuits specifically designed to achieve a neural network.

The one or more hardware processors 206 execute a variety of processing in corporation with various computer programs stored in advance in the ROM 222 or the storage device 208 with a predetermined area of the RAM 224 serving as the work area, and collectively control the operation of the units constituting the information processing device 100. The one or more hardware processors 206 also control the operation device 210, the display device 212, the communications device 214, and the like in corporation with the computer programs stored in advance in the ROM 222 or the storage device 208.

The storage device 208 is a rewritable storage device, such as a semiconductor storage medium like flash memory, or a storage medium that is magnetically or optically recordable. The storage device 208 stores therein computer programs to be used to control the information processing device 100, a variety of configuration information, and the like.

The operation device 210 is an input device, such as a mouse and a keyboard. The operation device 210 receives information that a user has input, and outputs the received information to the one or more hardware processors 206.

The display device 212 displays information to a user. The display device 212 receives information and the like from the one or more hardware processors 206, and displays the received information. In a case where information is output to a device, such as the communications device 214 or the storage device 208, the information processing device 100 does not have to include the display device 212.

The communications device 214 communicates with external equipment, thereby transmitting and receiving information through a network and the like.

A computer program executed on the information processing device 100 of the present embodiment is recorded on a computer-readable recording medium, such as a CD-ROM, a flexible disk (FD), a CD-R, and a digital versatile disc (DVD), in an installable or executable file, and is provided as a computer program product.

A computer program executed on the information processing device 100 of the present embodiment may be configured to be stored on a computer connected to a network, such as the Internet, and to be provided by being downloaded via the network. A computer program executed on the information processing device 100 of the present embodiment may also be configured to be provided or distributed via a network, such as the Internet. A computer program executed on the information processing device 100 of the present embodiment may also be configured to be provided by being preinstalled on ROM and the like.

A computer program executed on the information processing device 100 according to the present embodiment can cause a computer to function as units of the information processing device 100, which will be described later. The one or more hardware processors 206 read a computer program from a computer-readable storage medium on a main storage device, thereby enabling this computer to run.

The hardware configuration illustrated in FIG. 1 is an example, and a hardware configuration is not limited thereto. A single device may include all or part of the information processing device 100, the controller 200, the robot 300, and the sensor 400. For example, the robot 300 may include the functions of the information processing device 100, the controller 200, and the sensor 400 as well. The information processing device 100 may include the functions of the controller 200 or the sensor 400, or both. Additionally, while FIG. 1 illustrates that the information processing device 100 functions also as a training device, the information processing device 100 and a training device may be implemented by devices that are physically different from each other.

A functional configuration of the information processing device 100 will be described next. FIG. 4 is a functional block diagram illustrating an example of the functional configuration of the information processing device 100. As illustrated in FIG. 4, the information processing device 100 includes an acquisition unit 101, a training unit 102, an inference unit 103, a detection unit 104, an operation control unit 105, an output control unit 106, and a storage unit 121.

The acquisition unit 101 acquires a variety of information used in a variety of processing that the information processing device 100 performs. For example, the acquisition unit 101 acquires training data to train a neural network. While training data may be acquired in any way, the acquisition unit 101 acquires training data that has been created in advance, for example, from external equipment through a network and the like, or a storage medium.

The training unit 102 trains the neural network by using the training data. The neural network inputs image information of the object 500 taken by the imaging unit 301 and tactile information obtained by the tactile sensor 302, for example, and outputs output data that is at least one of the position and the posture of the object 500.

The training data is data in which the image information, the tactile information, and at least one of the position and the posture of the object 500 (correct answer data) are associated with each other, for example. The training unit 102 trains using such training data, which provides a neural network that outputs output data indicating at least one of the position and the posture of the object 500 to the input image information and tactile information. The output data indicating at least one of the position and the posture includes output data indicating the position, output data indicating the posture, and output data indicating both the position and the posture. An exemplary configuration of the neural network and the details of a training method will be described later.

The inference unit 103 makes an inference using the trained neural network. For example, the inference unit 103 inputs the image information and the tactile information to the neural network, and obtains the output data output by the neural network, the output data indicating at least one of the position and the posture of the object 500.

The detection unit 104 detects information to be used to control the operation of the robot 300. For example, the detection unit 104 detects a change in at least one of the position and the posture of the object 500 by using a plurality of items of output data that have been obtained by the inference unit 103. The detection unit 104 may detect, relative to at least one of the position and the posture of the object 500 at a point in time when grasp of the object 500 has begun, a change undergone thereafter in at least one of the position and the posture of the object 500. The relative change includes a change caused by rotation or translation (translational motion) of the object 500 with respect to the grasping part 311. Information about such a relative change can be used in in-hand manipulation or the like that controls at least one of the position and the posture of the object 500 with the object grasped.

If the position and the posture of the object 500 on the absolute coordinates at the point in time when grasp of the object 500 has begun are obtained, a change in the position and the posture of the object 500 on the absolute coordinates can also be determined from information about the detected relative change. In a case where the imaging unit 301 is installed in the outside of the robot 300, the detection unit 104 may be configured to determine positional information of the robot 300 relative to the imaging unit 301. In this manner, the position and the posture of the object 500 on the absolute coordinates can be determined more easily.

The operation control unit 105 controls the operation of the robot 300. For example, the operation control unit 105 refers to the change in at least one of the positions and the posture of the object 500 that the detection unit 104 has detected, and controls positions of the grasping part 311 and the robot 300 or the like so as to attain desired position and posture of the object 500. More specifically, the operation control unit 105 generates an operation command to operate the robot 300 so as to attain a desired position and posture of the object 500, and transmit the operation command to the controller 200, thereby causing the robot 300 to operate.

The output control unit 106 controls output of a variety of information. For example, the output control unit 106 controls processing to display information on the display device 212 and processing to transmit and receive information through a network by using the communications device 214.

The storage unit 121 stores therein a variety of information used in the information processing device 100. For example, the storage unit 121 stores therein parameters (such as a scale factor and a bias) for the neural network and the training data to train the neural network. The storage unit 121 is implemented by the storage device 208 in FIG. 3, for example.

The above-mentioned units (the acquisition unit 101, the training unit 102, the inference unit 103, the detection unit 104, the operation control unit 105, and the output control unit 106) are implemented by the one or more hardware processors 206, for example. For example, the above-mentioned units may be implemented by causing one or more CPUs to execute computer programs, that is, by software. The above-mentioned units may be implemented by a hardware processor, such as a dedicated integrated circuit (IC), that is, by hardware. The above-mentioned units may be implemented by making combined use of software and hardware. In a case where a plurality of processors are used, each processor may implement one of the units or may implement two or more of the units.

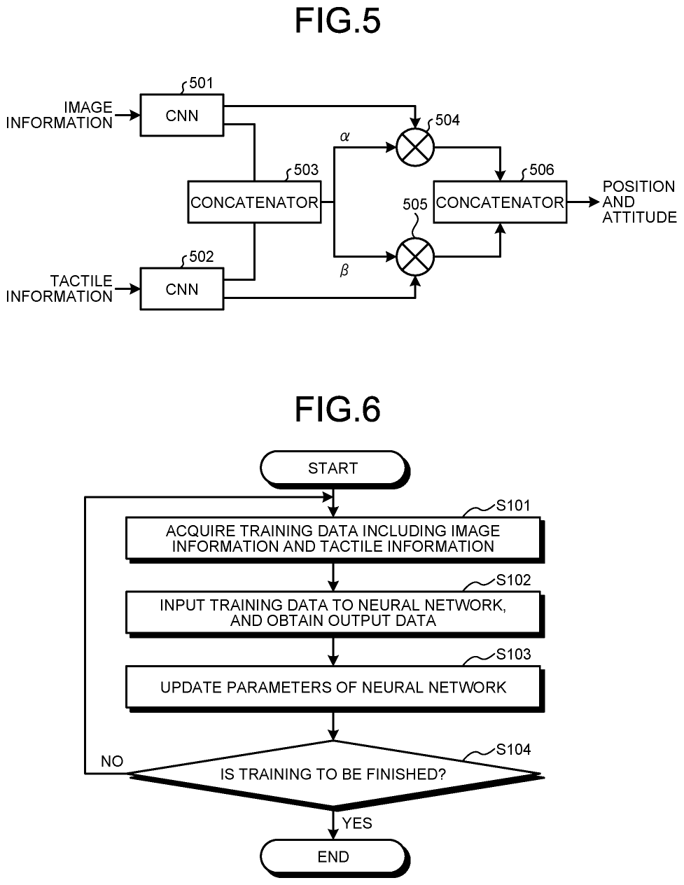

An exemplary configuration of a neural network will be described next. A description will be given below by taking, as an example, a neural network in which two pieces of information, image information and tactile information, are input and the position and the posture of the object 500 are output. FIG. 5 is a diagram illustrating the exemplary configuration of the neural network. While the description will be given below by taking, as an example, a configuration of a neural network including convolutional neural networks (CNNs), a neural network other than the CNNs may be used. The neural network illustrated in FIG. 5 is an example, and a neural network is not limited thereto.

As illustrated in FIG. 5, the neural network includes a CNN 501, a CNN 502, a concatenator 503, a multiplier 504, a multiplier 505, and a concatenator 506. The CNNs 501 and 502 are CNNs to which image information and tactile information are input, respectively.

The concatenator 503 concatenates output from the CNN 501 and output from the CNN 502. The concatenator 503 may be configured as a neural network. For example, the concatenator 503 can be a fully connected neural network, but is not limited thereto. The concatenator 503 is a neural network to which the output from the CNN 501 and the output from the CNN 502 are input and that outputs α and β (two-dimensional information), for example. The concatenator 503 may be a neural network that outputs a alone or β alone (one-dimensional information). In the former, β can be calculated by β=1−α, for example. In the latter, α can be calculated by α=1−β, for example. The concatenator 503 may control the range of output by using the ReLu function, the sigmoid function, and the softmax function, for example. For example, the concatenator 503 may be configured to output α and β satisfying α+β=1.

The number of pieces of information to be input to the concatenator 503, in other words, the number of sensors, is not limited to two, and may be N (N is an integer that is equal to or greater than two). In this case, the concatenator 503 may be configured to receive the outputs from CNNs corresponding to the respective sensors and to output N-dimensional or (N−1)-dimensional information (such as α, β, and γ).

The multiplier 504 multiplies the output from the CNN 501 by α. The multiplier 505 multiplies the output from the CNN 502 by β. The values α and β are values (vectors, for example) calculated based on output from the concatenator 503. The values α and β are values respectively corresponding to the contribution of image information (first contribution) and the contribution of tactile information (second contribution) to the final output data of the neural network (at least one of the position and the posture). For example, a middle layer that receives the output from the concatenator 503 and outputs α and β is included in the neural network, which enables α and β to be calculated.

The values α and β can also be interpreted as values indicating the extent (usage rate) to which the image information and the tactile information are respectively used to calculate output data, the weight of the image information and the tactile information, the confidence of the image information and the tactile information, and the like.

In the conventional technique called attention, a value is calculated that indicates to which part on an image attention is paid, for example. Such a technique may cause the problem that attention is paid to some data to which attention has been applied even in a state where the confidence (or correlation of data) of input information (such as image information) is low, for example.

Contrarily, the contributions (usage rates, weight, or confidence) of the image information and the tactile information to the output data are calculated in the present embodiment. For example, in a case where the confidence of the image information is low, α approaches zero. A result obtained by multiplying the output from the CNN 501 by the value α is used in calculating the final output data. This means that, in a case where the image information is unreliable, the usage rate of the image information in calculating the final output data decreases. Such a function enables estimation of the position and the posture of an object with higher accuracy.

The output from the CNN 501 to the concatenator 503 and the output from the CNN 501 to the multiplier 504 may be the same or different from each other. The outputs from the CNN 501 may have the number of dimensions different from each other. Likewise, the output from the CNN 502 to the concatenator 503 and the output from the CNN 502 to the multiplier 505 may be the same or different from each other. The outputs from the CNN 502 may have the number of dimensions different from each other.

The concatenator 506 concatenates the output from the multiplier 504 and the output from the multiplier 505, and outputs a concatenation result as output data indicating at least one of the position and the posture of the object 500. The concatenator 506 may be configured as a neural network. For example, the concatenator 503 can be a fully connected neural network and a long short-term memory (LSTM) neural network, but is not limited thereto.

In a case where the concatenator 503 outputs a alone or β alone as described above, it can also be interpreted that a alone or β alone is used to obtain output data. That is, the inference unit 103 can obtain output data on the basis of at least one of the contribution α of the image information and the contribution β of the tactile information.

training processing performed by the information processing device 100 configured in this manner according to the present embodiment will be described next. FIG. 6 is a flowchart illustrating an example of the training processing according to the embodiment.

First, the acquisition unit 101 acquires training data including image information and tactile information (step S101). The acquisition unit 101 acquires training data that has been acquired from external equipment, for example, through a network and the like, and that has been stored in the storage unit 121. Generally, training processing is performed repeatedly a plurality of times. The acquisition unit 101 may acquire part of a plurality of items of training data as training data (batch) to be used for each training.

Next, the training unit 102 inputs the image information and the tactile information included in the acquired training data to a neural network, and obtains output data that the neural network outputs (step S102).

The training unit 102 updates parameters of the neural network by using the output data (step S103). For example, the training unit 102 updates parameters of neural network so as to minimize an error (E1) between the output data and correct answer data (correct answer data indicating at least one of the position and the posture of the object 500) included in the training data. While the training unit 102 may use any kind of algorithm for training, the training unit 102 can use backpropagation, for example, for training.

As described above, α and β represent the contributions of the image information and the tactile information to the output data. Thus, the training unit 102 may train so that α and β satisfy α+β=1. For example, the training unit 102 may train so that an error E (E=E1+E2) produced by adding, to the error E1, an error E2 given so as to be a minimum in a case where α+β=1.

The training unit 102 determines whether to finish training (step S104). For example, the training unit 102 determines to finish training on the basis of whether all training data has been processed, whether the magnitude of correction of the error has become smaller than a threshold value, whether the number of times of training has reached an upper limit, or the like.

If training has not been finished (No at step S104), the process returns to step S101, and the processing is repeated for a new item of training data. If training is determined to have been finished (Yes at step S104), the training processing finishes.

The training processing as described above provides a neural network that outputs output data indicating at least one of the position and the posture of the object 500 to input data including image information and tactile information. This neural network can be used not only to output output data but also to obtain the contributions α and β from the middle layer.

According to the present embodiment, a type of training data that contributes to training can be changed in response to the training progress. For example, by increasing the contribution of image information at the early stage of training and increasing the contribution of tactile information halfway, training can be started from a part that is easy to train, which makes it possible to promote training more efficiently. This enables training in a shorter time than general neural network training (such as multimodal training that does not use attention) to which a plurality of pieces of input information are input.

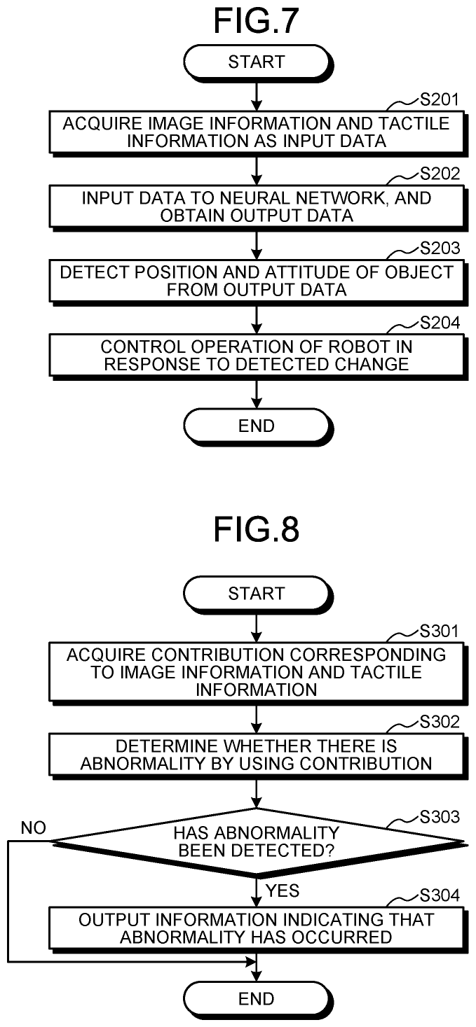

Control processing performed on the robot 300 by the information processing device 100 according to the present embodiment will be described next. FIG. 7 is a flowchart illustrating an example of the control processing according to the present embodiment.

The acquisition unit 101 acquires, as input data, image information that has been taken by the imaging unit 301 and tactile information that has been detected by the tactile sensor 302 (step S201). The inference unit 103 inputs the acquired input data to a neural network, and obtains output data that the neural network outputs (step S202).

The detection unit 104 detects a change in at least one of the position and the posture of the object 500 by using the obtained output data (step S203). For example, the detection unit 104 detects a change in the output data relative to a plurality of items of input data obtained at a plurality of times. The operation control unit 105 controls the operation of the robot 300 in response to the detected change (step S204).

According to the present embodiment, in a case where an abnormality of the imaging unit 301, a deterioration in the imaging environment (such as lighting), and the like lower the confidence of the image information, for example, output data is output with the contribution of the image information lowered by processing by the inference unit 103. In a case where an abnormality of the tactile sensor 302 and the like lower the confidence of the tactile information, for example, output data is output with the contribution of the tactile information lowered by processing by the inference unit 103. This enables estimation of output data indicating at least one of the positions and the posture of an object with higher accuracy.

### First Modification

In a case where a contribution excessively different from that in training is output frequently or continuously, it can be determined that a breakdown or an abnormality has occurred in a sensor (the imaging unit 301, the tactile sensor 302). For example, in a case where information (image information, tactile information) output from the sensor includes only noise because of the breakdown, or in a case where the value is zero, the value of the contribution of the relevant information approaches zero.

Thus, the detection unit 104 may further include a function of detecting an abnormality of the imaging unit 301 and the tactile sensor 302 on the basis of at least one of the contribution α of the image information and the contribution β of the tactile information. While the way to detect (determine) an abnormality on the basis of the contribution may be any method, the following way can be applied, for example.
In a case where a change in the contribution a is equal to or greater than a threshold value (first threshold value), it is determined that an abnormality has occurred in the imaging unit 301.
In a case where a change in the contribution β is equal to or greater than a threshold value (second threshold value), it is determined that an abnormality has occurred in the tactile sensor 302.
In a case where a change in the contribution α is equal to or smaller than the threshold value (first threshold value), it is determined that an abnormality has occurred in the imaging unit 301.
In a case where a change in the contribution β, is equal to or smaller than the threshold value (second threshold value), it is determined that an abnormality has occurred in the tactile sensor 302.

For example, in a case where the relation α+β=1 is satisfied, if the detection unit 104 can obtain one of α and β, the detection unit 104 can also obtain the other. That is the detection unit 104 can detect an abnormality of at least one of the imaging unit 301 and the tactile sensor 302 on the basis of at least one of α and β.

For a change in the contribution, a mean value of a plurality of changes in the contributions obtained within a predetermined period may be used. A change in the contribution obtained by one inference may also be used. That is, if once the contribution indicates an abnormal value, the detection unit 104 may determine that an abnormality has occurred in a corresponding sensor.

The operation control unit 105 may stop the operation of a sensor (the imaging unit 301, the tactile sensor 302) in which an abnormality has occurred. For example, in a case where an abnormality has been detected in the imaging unit 301, the operation control unit 105 may stop the operation of the imaging unit 301. In a case where an abnormality has been detected in the tactile sensor 302, the operation control unit 105 may stop the operation of the tactile sensor 302.

In a case where the operation control unit 105 has stopped the operation, the corresponding information (image information or tactile information) might not be output. In such an event, the inference unit 103 may input information for use at an abnormal condition (the image information and the tactile information in which all pixel values are zero, for example), for example, to the neural network. In view of the case where the operation is stopped, the training unit 102 may train the neural network by using training data for use at an abnormal condition. This enables a single neural network to deal with both cases where only part of the sensors is operated and where all the sensors are operated.

Stopping the operation of a sensor (the imaging unit 301, the tactile sensor 302) in which an abnormality has occurred enables a reduction in calculation cost and a reduction in power consumption, for example. The operation control unit 105 may be capable of stopping the operation of a sensor regardless of whether there is an abnormality. For example, in a case where a reduction in calculation cost is specified and in a case where a low-power mode is specified, the operation control unit 105 may stop the operation of a specified sensor. The operation control unit 105 may stop the operation of a sensor with a lower contribution, of the imaging unit 301 and the tactile sensor 302.

In a case where the detection unit 104 has detected an abnormality, the output control unit 106 may output information (abnormality information) indicating that the abnormality has been detected. While the abnormality information may be output in any way, a method for displaying the abnormality information on the display device 212 or the like, a method for outputting the abnormality information by lighting equipment emitting light (blinking), a method for outputting the abnormality information by a sound by using a sound output device, such as a speaker, and a method for transmitting the abnormality information to external equipment (such as a management workstation and a server device) through a network by using the communications device 214 or the like, for example, can be applied. By outputting the abnormality information, a notification that an abnormality has occurred (the state is different from a normal state) can be provided, even if the detailed cause of the abnormality is unclear, for example.

FIG. 8 is a flowchart illustrating an example of abnormality detection processing according to the present modification. In the abnormality detection processing, the contribution obtained when inferences (step S202) are made using the neural network in the control processing illustrated in FIG. 7, for example, is used. Consequently, the control processing and the abnormality detection processing may be performed in parallel.

The detection unit 104 acquires the contribution a of the image information and the contribution β of the tactile information that are obtained when inferences are made (step S301). The detection unit 104 determines whether there is an abnormality in the imaging unit 301 and the tactile sensor 302 by using the contributions α and β, respectively (step S302).

The output control unit 106 determines whether the detection unit 104 has detected an abnormality (step S303). If the detection unit 104 has detected an abnormality (Yes at step S303), the output control unit 106 outputs the abnormality information indicating that the abnormality has occurred (step S304). If the detection unit 104 has not detected an abnormality (No at step S303), the abnormality detection processing finishes.

### Second Modification

In the above-mentioned embodiment and the modification, the neural network to which the two types of information, image information and tactile information, are input has been described. The configuration of the neural network is not limited thereto, and a neural network to which other two or more pieces of input information are input may be possible. For example, a neural network to which one or more pieces of input information other than the image information and the tactile information are further input and a neural network to which a plurality of pieces of input information types of which are different from the image information and the tactile information may be used. Even in a case where the number of pieces of input information is three or more, the contribution may be specified for each piece of input information, like α, β, and γ. The abnormality detection processing as illustrated in the first modification may be performed by using such a neural network.

The mobile device to be operated is not limited to the robot, and may be a vehicle, such as an automobile, for example. That is, the present embodiment can be applied to an automatic vehicle-control system using a neural network in which image information around the vehicle obtained by the imaging unit 301 and range information obtained by a laser imaging detection and ranging (LIDAR) sensor serve as input information, for example.

The input information is not limited to information input from sensors, such as the imaging unit 301 and the tactile sensor 302, and may be any kind of information. For example, information input by a user may be used as the input information to the neural network. In this case, applying the above-mentioned first modification enables detection of wrong input information input by the user, for example.

A designer of a neural network does not have to consider which of a plurality of pieces of input information should be used, and has only to build a neural network so that a plurality of pieces of input information are all input, for example. This is because, with a neural network that has trained properly, output data can be output with the contribution of a necessary piece of input information increased and the contribution of an unnecessary piece of input information decreased.

The contribution obtained after training can also be used to discover an unnecessary piece of input information if a plurality of pieces of input information. This enables construction (modification) of a system so that a piece of input information with a low contribution is not used, for example.

For example, a case is considered where a system including a neural network to which pieces of image information obtained by a plurality of imaging units is input. First, the neural network is constructed so that pieces of image information obtained by all the imaging units is input, the neural network is trained in accordance with the above-mentioned embodiment. The contribution obtained by training is verified, and the system is designed so that an imaging unit corresponding to the piece of image information with a low contribution is not used. In this manner, the present embodiment enables increased efficiency of system integration of a system including a neural network using a plurality of pieces of input information.

The present embodiment includes the following aspects, for example.

### First Aspect

An information processing device comprising:
an inference unit configured to input, to a neural network, a plurality of pieces of input information about an object grasped by a grasping part, and to obtain output data indicating at least one of a position and an posture of the object; and
a detection unit configured to detect an abnormality of each of the pieces of the input information, based on a plurality of contributions each indicating a degree of contribution of each of the pieces of the input information to the output data.

### Second Aspect

The information processing device according to the first aspect, wherein, in a case where a change in the contribution is equal to or greater than a threshold value, the detection unit determines that an abnormality has occurred in the corresponding piece of the input information.

### Third Aspect

The information processing device according to the first aspect, wherein, in a case where the contribution is equal to or smaller than a threshold value, the detection unit determines that an abnormality has occurred in the corresponding piece of the input information.

### Fourth Aspect

The information processing device according to the first aspect, further comprising an operation control unit configured to stop operation of a sensing part that generates the piece of the input information in a case where an abnormality has been detected in the piece of the input information.

In the present specification, the expression “at least one of a, b, and c” or “at least one of a, b, or c” includes any combination of a, b, c, a-b, a-c, b-c, and a-b-c. The expression also covers a combination with a plurality of instances of any element, such as a-a, a-b-b, and a-a-b-b-c-c. The expression further covers addition of an element other than a, b, and/or c, like having a-b-c-d.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
at least one memory; and
at least one processor configured to:
acquire at least first information of an object and second information of the object, the first information being different from the second information, and
obtain, by inputting at least the first information and the second information into at least one neural network, output data for controlling a mobile device,
wherein the output data is generated based on at least one of a first contribution of the first information and a second contribution of the second information, the at least one of the first contribution and the second contribution being determined by utilizing the at least one neural network.

2. The information processing device according to claim 1, wherein
the output data is utilized for controlling at least one of a position and a posture of the mobile device.

3. The information processing device according to claim 1, wherein
the output data indicates at least one of a position and a posture of the object.

4. The information processing device according to claim 3, wherein
the at least one processor is further configured to detect a change in at least one of the position and the posture of the object, based on a plurality of pieces of the output data obtained by inputting a plurality of pieces of the first information and a plurality of pieces of the second information into the at least one neural network.

5. The information processing device according to claim 4, wherein
the at least one processor is further configured to control the mobile device to place the object in at least one of desired position and posture, by referring to change, the mobile device so as to attain as least one of desired position and posture of the object.

6. The information processing device according to claim 1, wherein the first contribution is determined based on the first information and the second information.

7. The information processing device according to claim 1, wherein
the at least one processor is further configured to detect an abnormality of at least one of a first device that detects the first information and a second device that detects the second information, based on at least one of the first contribution and the second contribution.

8. The information processing device according to claim 7, wherein, in a case where a change in the first contribution is equal to or greater than a first threshold value, or in a case where a change in the second contribution is equal to or greater than a second threshold value, the at least one processor is configured to determine that an abnormality has occurred in at least one of the first device and the second device.

9. The information processing device according to claim 7, wherein, in a case where the first contribution is equal to or smaller than a first threshold value, or in a case where the second contribution is equal to or smaller than a second threshold value, the at least one processor is configured to determine that an abnormality has occurred in at least one of the first device and the second device.

10. The information processing device according to claim 7, wherein the at least one processor is further configured to stop operation of the first device in a case where an abnormality has been detected in the first device, and stop operation of the second device in a case where an abnormality has been detected in the second device.

11. The information processing device according to claim 1, wherein
the mobile device is a vehicle,
the first information is image information of the object around the vehicle, and
the second information is range information of the object around the vehicle.

12. The information processing device according to claim 1, wherein
the mobile device is a robot,
the first information is image information of the object, and
the second information is tactile information indicating a contact state between the robot and the object.

13. The information processing device according to claim 12, wherein the tactile information is information indicating the condition of contact in an image format.

14. The information processing device according to claim 1, wherein
the at least one neural network includes a first neural network and a second neural network,
the first information is inputted into the first neural network, and
the second information is inputted into the second neural network.

15. The information processing device according to claim 14, wherein
the at least one neural network further includes a third neural network, and
the third neural network is configured to output, by inputting an output the at least one of the first contribution and the second contribution in response to receipt of an output from the first neural network, the at least one of the first contribution and the second contribution.

16. The information processing device according to claim 15, wherein
the at least one neural network further includes a fourth neural network, and
the fourth neural network is configured to output the output data by utilizing an output from the first neural network, an output from the second neural network, and the at least one of the first contribution and the second contribution.

17. The information processing device according to claim 1, wherein the first contribution of the first information is changed based on confidence of the first information.

18. A system comprising:
the information processing device according to claim 1;
at least one controller; and
the mobile device, wherein
the at least one controller controls driving of the mobile device based on information from the information processing device.

19. An information processing method comprising:
by at least one processor,
acquiring at least first information of an object and second information of the object, the first information being different from the second information, and
obtaining, by inputting at least the first information and the second information into at least one neural network, output data for controlling a mobile device,
wherein the output data is generated based on at least one of a first contribution of the first information and a second contribution of the second information, the at least one of the first contribution and the second contribution being determined by utilizing the at least one neural network.

20. A computer program product comprising a non-transitory computer readable medium including programmed instructions, wherein the instructions, when executed by at least one computer, cause the at least one computer to execute:
acquiring at least first information of an object and second information of the object, the first information being different from the second information, and
obtaining, by inputting at least the first information and the second information into at least one neural network, output data for controlling a mobile device,
wherein the output data is generated based on at least one of a first contribution of the first information and a second contribution of the second information, the at least one of the first contribution and the second contribution being determined by utilizing the at least one neural network.
